(19) United States
(12) Patent Application Publication
(10) Pub. No.: US 2026/0195201 A1
(43) Pub. Date: Jul. 9, 2026

(54) MANAGING INCIDENT PROCESSING QUEUES IN GEOGRAPHICALLY DISTRIBUTED DATA CENTERS

(71) Applicant: T-Mobile USA, Inc., Bellevue, WA (US)

(72) Inventors: Justin Micah Leonard, Bellevue, WA (US); Sanath Raj, Snoqualmie, WA (US)

(21) Appl. No.: 19/011,163

(22) Filed: Jan. 6, 2025

(51) Int. Cl. G06F 9/54

(52) U.S. Cl. CPC G06F 9/546; G06F 9/542

(57) ABSTRACT

A queue application programming interface (QAPI) in a first data center receives incident messages, each with an incident identifier. The first data center is in communication with additional data centers. The messages are either ordered or unordered. Ordered messages must be processed in the order received, while unordered messages do not. The QAPI transmits the messages to a message stream data structure. A first worker sub-system retrieves unordered messages from the message stream for processing. In parallel, the QAPI transmits the messages to a group stream data structure which arranges the messages into groups. A second worker sub-system retrieves groups of ordered messages for processing. At least one of the first or second worker sub-systems is associated with the additional data centers.

### BACKGROUND

Incident processing in software refers to the systematic approach of identifying, documenting, analyzing, and resolving incidents that disrupt normal operations or degrade the performance of software systems. Such incidents can include software bugs, system crashes, security breaches, or any unexpected behavior that impacts the functionality of the software. Effective incident processing is essential for maintaining software reliability, minimizing downtime, and ensuring a seamless user experience. An incident processing queue in software is a structured system used to manage the processing of incident messages (or tickets). Incident processing queues can facilitate addressing incident messages in a manner that optimizes the efficiency and effectiveness of the incident resolution process.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates a geographically distributed data center system in accordance with some implementations of the present technology.

FIG. 3 is a block diagram that illustrates a data center for managing incident processing queues in accordance with some implementations of the present technology.

FIG. 4 is a sequence chart that illustrates a workflow for transmitting incident messages to a data store in accordance with some implementations of the present technology.

FIG. 5 is a sequence chart that illustrates a workflow for retrieving incident messages from a data store in accordance with some implementations of the present technology.

FIG. 6 is a flowchart that illustrates processes for managing incident processing queues in accordance with some implementations of the present technology.

FIG. 7 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology is directed to managing incident processing queues. There is a need for highly scalable and efficient incident processing that could address processing increasing and fluctuating volumes of incidents without compromising response times, service quality and reliable performance. An ability to process incidents across geographically distributed data centers could increase scalability and enable efficient resource utility. Geographically distributed data centers can also provide for geo-redundancy and high availability. However, processing of incidents in geographically distributed data centers (e.g., data centers located in different states or different countries) is challenging because conventional queuing methods cannot enable processing for ordered incident messages (e.g., incident messages related to an incident that need to be processed in an order they were received) in distributed data centers without compromising the order of the messages being processed. For example, distributed data centers can experience network latency due to geographical distance which can cause incident messages retrieved from an ordered queue by distributed data centers to be processed out of order (e.g., the latency delays the processing of incident messages retrieved by a data center located distance away from the data center maintaining the queue). The latency can also cause challenges for accurate load balancing, coordination and synchronization of data stores, and maintenance of the status of incident messages when retrieving incident messages from a queue for processing by distributed data centers. Therefore, there is a need for ordered queuing systems that can be worked concurrently by multiple workers (e.g., worker sub-systems) from distributed data centers.

The present technology provides for methods and systems for operating data structures that facilitate grouping of ordered instance messages in queues based on incident identifiers. A group can include multiple ordered incident messages associated with a single incident. The multiple ordered incident messages within the group can be retrieved for processing by worker sub-systems of geographically distributed data centers. The groups are arranged so that a worker can process the incident messages of a group in the order they are received, as is required in order to successfully resolve the incident. Further, the present technology provides for data structures that enable processing of unordered incident messages concurrently with the ordered, grouped incident messages by operation of separate, parallel queue streams. The status of incident messages in the parallel streams, i.e., the unordered stream and the ordered, grouped stream, is managed by a state data structure.

The present technology provides for highly-scalable queues of incident messages that enable incident messages to be retrieved and processed without compromising the requirements of ordered incident messages. Such queues allow for efficient resource usage that is not limited to resources within a single data center but allows flexible processing across different centers. The disclosed queues further ensure that incident messages are processed reliably without interruptions. For example, in an incident where a single data center is experiencing congestion or interruptions, the ordered and unordered incident messages queued at that data center can be processed by other data centers without having significant delays.

In one example, a computer-implemented method for managing incident processing queues in geographically distributed data centers involves receiving incident messages by a queue application programming interface (QAPI) of a first data center. The first data center communicates with one or more additional data centers. Each incident message comprises an incident identifier associated with an incident. The incident messages include incident messages of an ordered type and unordered type.. Incident messages of the ordered type, associated with a particular incident, are required to be processed in the relative order they were received. Incident messages of the unordered type are not required to be processed in any specific order. In parallel, the method includes (i) transmitting incident messages to a message stream data structure of a data store of the first data center and retrieving a first incident message of a first subset of the unordered type by a first worker sub-system from the message stream data structure for processing and (ii) transmitting the incident messages to a group stream data structure of the data store of the first data center; arranging, by the group stream data structure, the incident messages into multiple locked groups; and retrieving incident messages of a first locked group of the ordered type by a second worker sub-system from the group stream data structure for processing. The first worker sub-system and/or the second worker sub-system are associated with one or more additional data centers different from the first data center.

In another example, a system for managing incident processing queues comprises at least one hardware processor and at least one non-transitory memory storing instructions. When executed by the hardware processor, these instructions cause the system to receive incident messages by a QAPI of a data center. Each incident message comprises an incident identifier associated with an incident. The incident messages include incident messages of an ordered type and unordered type. Incident messages of the ordered type, associated with a particular incident, are required to be processed in the relative order they were received. Incident messages ofthe unordered type are not required to be processed in any specific order. In parallel, the system (i) transmits, by the QAPI, the incident messages to a message stream data structure of a data store of the data center and retrieves a first incident message of a first subset of the unordered type by a first worker sub-system from the message stream data structure for processing and (ii) transmits, by the QAPI, the incident messages to a group stream data structure of the data store of the data center; distributes the incident messages into multiple locked groups; and retrieves incident messages of a first locked group of the ordered type by a second worker sub-system from the group stream data structure for processing.

In yet another example, a non-transitory, computer-readable storage medium comprises instructions recorded thereon. When executed by at least one data processor of a system, these instructions cause the system to receive incident messages by a QAPI of a data center. Each incident message comprises an incident identifier associated with an incident. The incident messages include incident messages of an ordered type and unordered type. Incident messages of the ordered type, associated with a particular incident, are required to be processed in the relative order they were received. Incident messages of the unordered type are not required to be processed in any specific order. In parallel, the system (i) transmits, by the QAPI, the incident messages to a message stream data structure of a data store of the data center and retrieves a first incident message of the first subset of the unordered type by a first worker sub-system from the message stream data structure for processing and (ii) transmits, by the QAPI, the incident messages to a group stream data structure of the data store of the data center; arranges, by the group stream data structure, the second subset into multiple locked groups; and retrieves incident messages of a first locked group of the ordered type by a second worker sub-system from the group stream data structure for processing.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

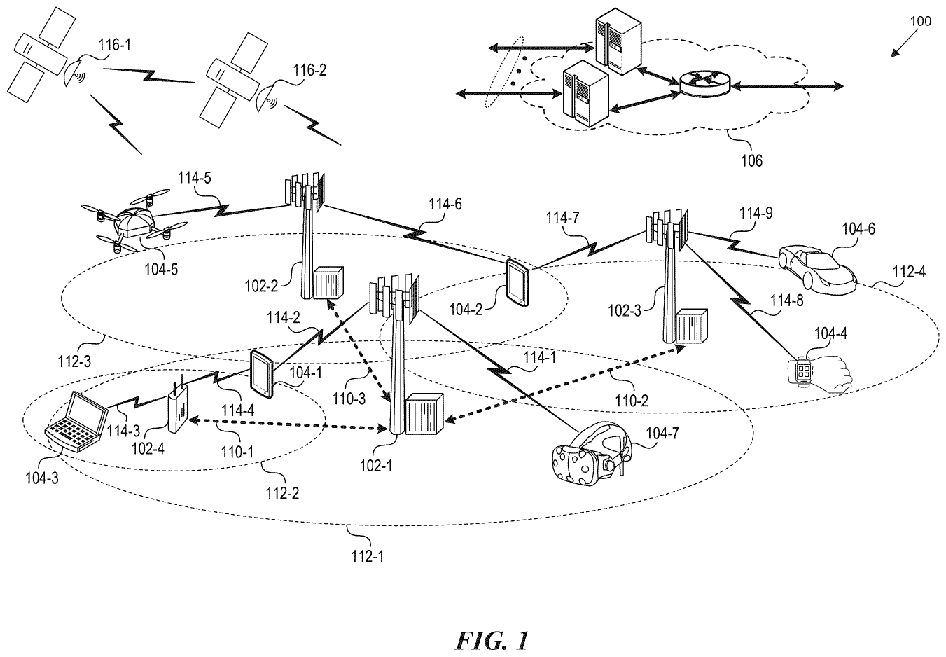

FIG. 1 is a block diagram that illustrates a wireless telecommunications network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104-1 through 104-7 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet Protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The geographic coverage area 112 for a base station 102 can be divided into sectors making up only a portion of the coverage area (not shown). The network 100 can include base stations of different types (e.g., macro and/or small cell base stations). In some implementations, there can be overlapping geographic coverage areas 112 for different service environments (e.g., Internet-of-Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term eNB is used to describe the base stations 102, and in 5G new radio (NR) networks, the term gNBs is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the system 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provides data to a remote server over a network; IoT devices such as wirelessly connected smart home appliances, etc.

A wireless device (e.g., wireless devices 104-1, 104-2, 104-3, 104-4, 104-5, 104-6, and 104-7) can be referred to as a user equipment (UE), a customer premise equipment (CPE), a mobile station, a subscriber station, a mobile unit, a subscriber unit, a wireless unit, a remote unit, a handheld mobile device, a remote device, a mobile subscriber station, terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102, and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or Time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites such as satellites 116-1 and 116-2 to deliver services anywhere and anytime and provide coverage in areas that are unreachable by any conventional Terrestrial Network (TN). A 6G implementation of the network 100 can support terahertz (THz) communications. This can support wireless applications that demand ultra-high quality of service requirements and multi-terabits per second data transmission in the 6G and beyond era, such as terabit-per-second backhaul systems, ultrahigh-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low User Plane latency. In yet another example of 6G, the network 100 can implement a converged Wi-Fi and Core architecture to increase and improve indoor coverage.

### Managing Incident Processing Queues

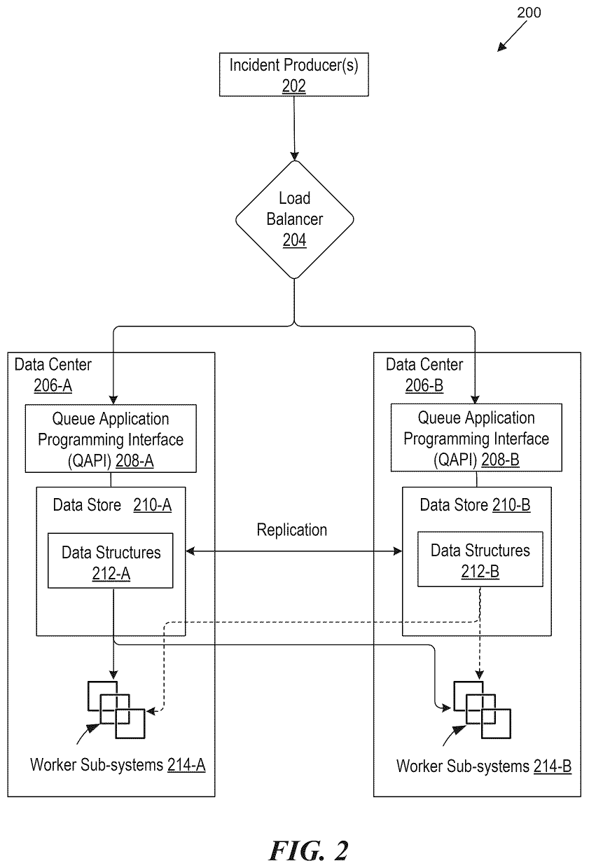

FIG. 2 is a block diagram that illustrates a geographically distributed data center system 200 in accordance with some implementations of the present technology. Data centers 206A and 206-B (collectively referred to as “data centers 206”) are configured for processing software incidents (e.g., software change requests, software bugs, system crashes, security breaches, or unexpected behavior of software) and network incidents (e.g., related to hardware or software failures, configuration errors, or cyberattacks). Specifically, the data center system 200 can be configured to manage the incident processing queues. In some implementations, the data center system 200 is associated with a telecommunications network (e.g., the network 100 of FIG. 1) and is configured to process software and network incidents arising from the operation of the network 100.

The data center system 200 can include multiple data centers (e.g., data centers 206-A and 206-B) in communication with each other. The data centers 206-A and 206-B are separate from each other and can be located in different geographical locations (e.g., different cities, states, countries). Each of the data centers 206-A and 206-B includes a queue application programming interface (QAPI) (e.g., QAPIs 208-A and 208-B, collectively referred to as “QAPIs 208”), a data store (e.g., data stores 210-A and 210-B, collectively referred to as “data stores 210”) including data structures (e.g., data structures 212-A and 212-B), and multiple worker sub-systems (e.g., worker sub-systems 214-A and 214-B).

The QAPIs 208 are configured to receive incident messages initiated by one or more incident producers 202 via a load balancer 204. The load balancer 204 can be configured to manage the processing bandwidth and capacity within the data center system 200 by transmitting incident messages to different data centers 206 based on their available capacity. The QAPIs 208 can be configured to manage queueing of the incident messages in the data stores 210 including transmitting the incident messages to different data structures 212 for queueing. In some implementations, the data stores 210 include remote dictionary servers including in-memory data structure stores used as databases, caches, and/or message brokers. The data stores 210 can facilitate storing incident messages in queues (e.g., strings, lists) and streams. In some implementations, the data stores 210 of the different data centers 206 are replicated among each other so that they include similar data and data structures (at any given time).

The worker sub-systems 214 are configured to retrieve the incident messages from the data stores 210 and process the incident messages. In some implementations, the processing refers to automated or semi-automated processes that prepare the incident messages to be further processed and resolved by operators. The operators can be part of the data center system 200 or be in communication with the data center system 200 (e.g., outside vendor operators).

As shown, the worker sub-systems 214-A and 214-B are in communication with the data stores of their home data centers as well as the data stores of the other data centers of the data center system 200. The worker sub-systems 214-A and 214-B can thereby retrieve incident messages queued at data stores across different data centers for processing. Such capability increases the distribution of processing capacity and allows the data center system 200 to scale up its processing bandwidth, as needed, by geographical distribution of the queued incident messages.

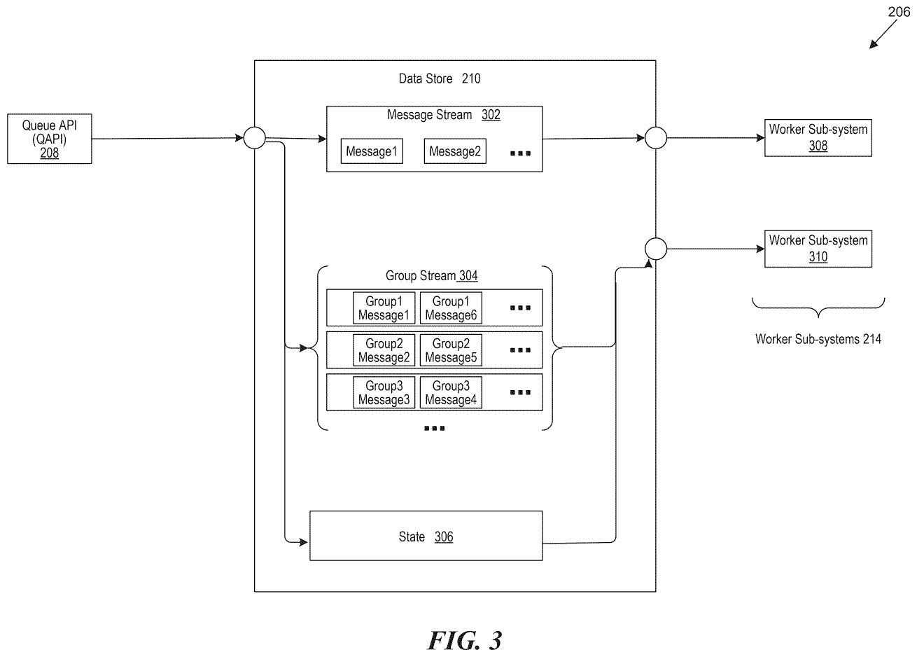

FIG. 3 is a block diagram that illustrates a data center 206 (e.g., corresponding to a data center 206-A or 206-B in FIG. 2) for managing incident processing queues in accordance with some implementations of the present technology. The data center 206 includes a QAPI 208, a data store 210, and worker sub-systems 214, as described with respect to FIG. 2.

The QAPI 208 is configured to transmit incident messages to data structures of the data store 210 to be queued for processing by the worker sub-systems 214. The QAPI 208 transmits all of the received incident message to all of the data structures configured to queue incident messages (e.g., as replicated incident messages). Each incident message includes an incident identifier associated with an incident. The incident identifier can be a sequential set of numbers or characters used to identify an incident. Several messages can be associated with a single incident. The incident messages can be of different types, such as ordered and unordered types. Incident messages of the ordered type need to be processed in the order they were received while unordered incident messages can be processed in any order. A software incident can be associated with a combination of unordered and ordered incident messages (e.g., having a common incident identifier). Queuing is a process of managing the order and delivery of incident messages between different components of a data center and enables processing of the incident messages in a reliable and sequential manner. Queueing can enable maintaining system stability and consistency by managing the bandwidth of the worker sub-systems. For example, during high traffic or failure scenarios, queuing has a role in preventing message loss and ensuring that incident messages are addressed in a required manner.

The data store 210 includes multiple data structures such as message stream 302, group stream 304, and state 306 data structures. The message stream 302 can be configured to receive and store unordered incident messages in a queue. The incident messages can be arranged sequentially (e.g., in a stream), for example, based on their incident identifiers. Unordered incident messages of the message stream 302 can be retrieved by a worker sub-system (e.g., a worker sub-system 308 of the worker sub-systems 214) configured to process unordered incident messages. The unordered incident messages can be retrieved in an order that is not necessarily related to their incident identifier or the order of in which the unordered incident messages were received. Instead, for example, messages can be retrieved for processing by pre-determined criteria, urgency, or impact on the operation of software.

In parallel (e.g., concurrently) with the queueing of the unordered incident messages in the message stream 302, the group stream 304 can be configured to receive and store incident messages in groups. Each group can include a set of ordered incident messages (e.g., two or more messages) that are related to a common incident and have a same incident number. To resolve the incident associated with the ordered incident messages, the ordered incident messages are required to be processed in the order they have been received. The groups can be queued in an order in accordance with the incident number or the time of receiving the ordered incident messages. A group of ordered incident messages can be retrieved by a worker sub-system (e.g., a worker sub-system 310 of the worker sub-systems 214) configured to process ordered incident messages. The groups can be retrieved in an order that is not necessarily related to their incident identifier or the order of in which the ordered incident messages were received (similar to the message stream 302 messages). However, the ordered incident messages belonging to the group need to be processed by the worker sub-system 310 in the order they are received.

The state 306 is configured to store the current status (e.g., status data) of each of the incident messages in the data store 210. The current status is updated based on information received from the QAPI 208. The current status includes the status (or state) of the queue (e.g., the queues at the data store 210) as well as status of individual incident messages and groups of incident messages. The current status can include information such as a message's position in a queue, its incident identifier, its priority level, timestamps for when it was added and last updated, and any relevant metadata or context needed for processing. By maintaining the current status of the incident messages in the data store 210, the state 306 can facilitate efficient operation and timely processing of the queues and prevent loss of messages.

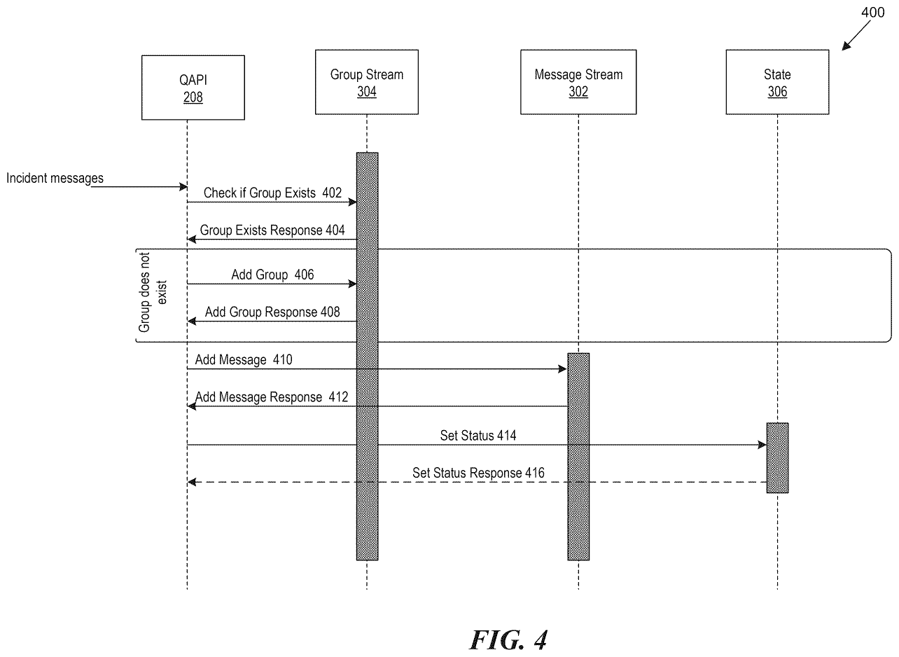

FIG. 4 is a sequence chart that illustrates a workflow 400 for transmitting incident messages to a data store in accordance with some implementations of the present technology. Subsequent to receiving an incident message, at 402 the QAPI 208 checks whether the group stream 304 already includes a group associated with an incident identifier of the incident message. At 404, the group stream 304 transmits a response to the QAPI 208. In an instance that a group exists, the incident message is added to the existing group at the group stream. In an instance that the group does not exist, at 406 the QAPI 208 instructs the group stream 304 to add a new group that includes the incident message. At 408, the group stream 304 responds to confirm that the new group that includes the ordered incident message is added.

In parallel, subsequent to receiving the incident message, at 410 the QAPI 208 also adds the incident message to the message stream 302. At 412, the message stream 302 responds to confirm that the incident message is added.

At 414, the QAPI 208 transmits an indication to the state 306 to set the status of the ordered and unordered incident messages. At 416, the state 306 responds back to the QAPI 208 to confirm that the status of incident messages and the status or state of the queues at the group stream data structure 304 and the message stream data structure 302 is updated. The status of all incident messages and the queues are updated responsive to any changes to their status occurring.

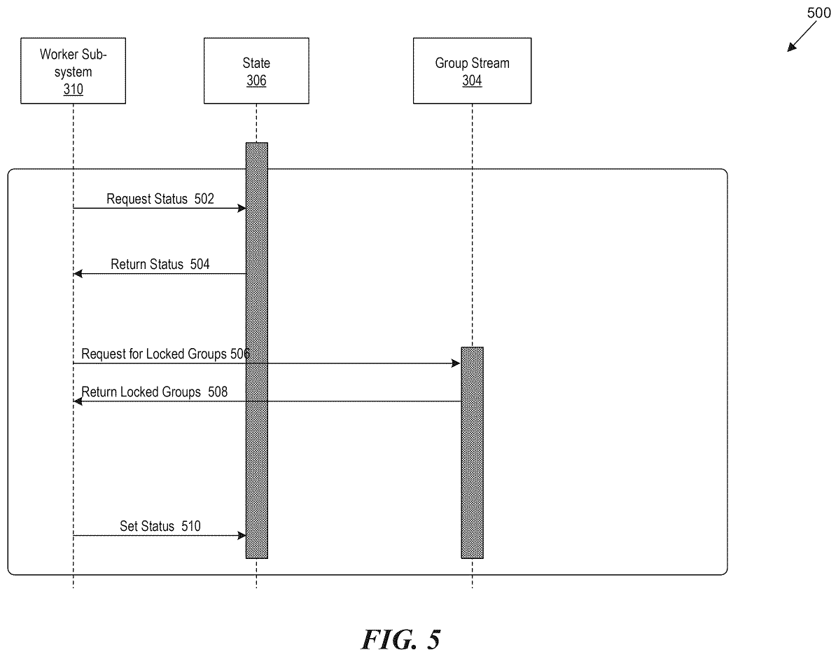

FIG. 5 is a sequence chart that illustrates a workflow 500 for retrieving incident messages from a data store in accordance with some implementations of the present technology. The worker sub-system 310 (for processing ordered/grouped incident messages) retrieves grouped incident messages for processing from the group stream 304. The worker sub-system 310 balances its own capacity and requests at least a number of groups it determines that it is able to process at its current capacity. Capacity can be determined based on the number of groups divided by the number of workers. As an example, the worker sub-system 310 can determine that it has capacity to process 10 groups but then retrieve an additional group (11 groups altogether) to ensure that it operates at the maximum capacity.

Prior to retrieving ordered incident messages, at 502, the worker sub-system 310 requests a status of grouped ordered incident messages from the state 306. The state 306 returns the status information at 504. Based on the status information, at 506, the worker sub-system 310 requests a number of locked groups from the group stream 304. A locked group can include a set of ordered incident messages associated with the same incident identifier that need to be processed in the order the incident messages are received (e.g., the incident messages have a locked order). At 508, the group stream 304 returns the locked groups to the worker sub-system 310. At 510, the worker sub-system 310 transmits an indication to the state 306 to set the status of retrieved incident messages and the status (or state) of the queue.

As described with respect to FIG. 2, the worker sub-systems are configured to retrieve incident messages from data stores of different data centers, in accordance with the workflow 500. For example, the worker sub-system 310 can determine, based on the requested status at 502, that the group stream 304 of its home data center does not have a sufficient number of groups corresponding to its full processing capacity. The worker subsystem 310 can then request a status of groups at another data center and retrieve additional groups from that data center if available. As explained with respect to FIG. 2, Indecent messages, groups, state (anything stored in the data store) can be replicated to all data centers 206 of the geographically distributed data center system 200. Worker sub-systems 214 only consume from a single data center at a time. In case of a disruption or disaster on one data center, the worker sub-systems 214 can be switched to retrieve incident messages from another data center without data or incident message loss. The QAPIs can produce messages to any data center at any time.

Such processing across data centers increases the flexibility, efficiency, and overall capability of the data centers to process incident messages.

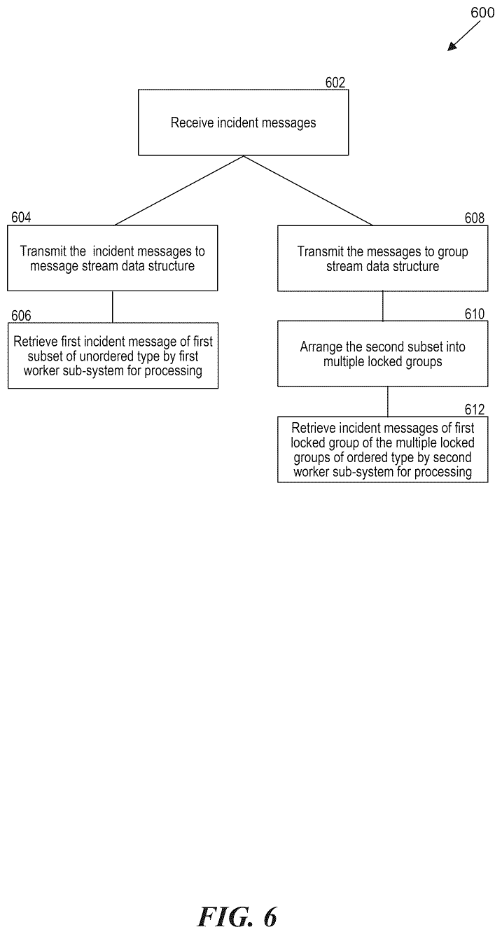

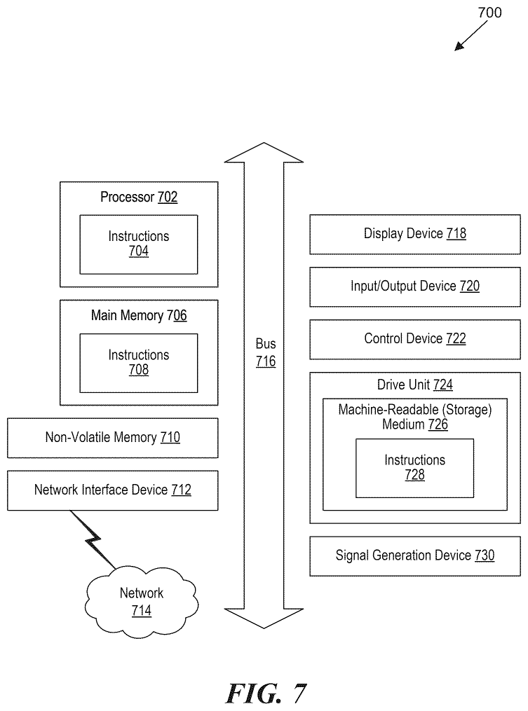

FIG. 6 is a flowchart that illustrates a process 600 for managing incident processing queues in accordance with some implementations of the present technology. The process 600 can be performed by a system (e.g., the data center 206 in FIG. 3 which is part of the data center system 200 in FIG. 2). In some implementations, the system is associated with a wireless network (e.g., the wireless network 100 in FIG. 1). The system can include at least one hardware processor and at least one non-transitory memory storing instructions (e.g., a computer system 700 described with respect to FIG. 7). When the instructions are executed by the at least one hardware processor, the server system performs the process 600.

At 602, the system receives incident messages by a queue application programming interface (QAPI) (e.g., the QAPI 208 in FIG. 3) of a first data center. The first data center is in communication with one or more additional data centers. In some implementations, the first data center is separate from the one or more additional data centers and is located a distance away from the one or more additional data centers. As described with respect to FIG. 2, the data centers 206 of the data center system 200 are in communication with each other and can be located separate from each other. The data centers can be located in different cities, states, or countries.

Each incident message comprises an incident identifier associated with an incident. The incident identifier can be a sequential string of letters and/or numbers. For example, the incident identifiers are sequential numbers that are assigned to incidents in an order that the incidents are received. The incident identifiers are unique in that all incident messages associated with a single incident have the same number.

The incident messages can include incident messages of an ordered type and unordered type. Incident messages of the ordered type, associated with a particular incident, are required to be processed in the relative order they were received. Incident messages of the unordered type are not required to be processed in any specific order. As an example, incident messages that require email notifications to be resolved are of the unordered type while incident messages that require asynchronous APIs (Application Programming Interfaces) processes, vendor transfers, an knowledge enrichment to be resolved are of the ordered type.

At 604, the QAPI transmits the incident messages to a message stream data structure (e.g., the message stream 302 in FIG. 3) of a data store of the first data center. At 608, a first worker sub-system of the first data center retrieves a first incident message of the first subset of the unordered type from the message stream data structure for processing. The unordered messages in the message stream 302 can be arranged in an order they were received. However, the messages can be retrieved and processed in any order without having an effect on the success of the processing and resolving of the incident. The first worker sub-system can be configured to process incident messages of the unordered type and it therefore only retrieves incident messages of the unordered type (while not retrieving incident messages of the ordered type). The first worker sub-system can identify a type of an incident message, e.g., based on the content of the incident message.

At 608, the QAPI transmits the incident messages to a group stream data structure (e.g., the group stream 304 in FIG. 3) of the data store of the first data center. The QAPI thereby transmits all incident messages to both of the message stream data structure and the group stream data structure. At 610, the group stream data structure arranges the incident messages into multiple locked groups. The incident messages in the locked groups are configured to be retrieved together and processed in an order they are received. Processing of the group is only finalized after all incident messages in the group are processed. For example, the status of the group will remain as “unprocessed” until all of the incident messages are processed. The arrangement into the locked groups can be done as the messages are received from the QAPI or in response to a request from a worker subsystem.

At 612, a second worker sub-system retrieves incident messages of a first locked group of the multiple locked groups of the ordered type from the group stream data structure for processing. In some implementations, the incident messages of the first locked group are associated with a particular software incident and are configured to be processed in the order they were received by the QAPI. The second worker sub-system can be configured to process incident messages of the ordered type and it therefore only retrieves the locked groups with incident messages of the ordered type (while not retrieving incident messages of the unordered type). The second worker sub-system can identify a type of incident messages in a locked group, e.g., based on the content of the incident messages.

In some implementations, at least one of the first worker sub-system and the second worker sub-system is associated with the one or more additional data centers different from the first data center while the QAPI, the group stream data structure and the message stream structure are associated with the first data center. For example, as shown in FIG. 2, the worker sub-system 214 of the data center 206-A can retrieve incident messages for processing from the data store 210-B of the data center 206-B.

The operations of 606 and 608 can be done in parallel (e.g., concurrently) with the operations 610 through 614. In some implementations, the first incident message and the incident messages of a first locked group are associated with a common software incident and comprise a common incident identifier. For example, a software incident can be associated with multiple incident messages of ordered and unordered types. These incident messages can be queued in parallel such that the ordered incident messages are in the queue of the group stream 304 and the unordered incident messages are in the queue of the message stream 302 in FIG. 3. The ordered and unordered messages can be queued concurrently in different data structures and can be retrieved for processing by the worker sub-systems 308 and 310 concurrently.

In some implementations, the system stores, by a state data structure (e.g., state 306 in FIG. 3) of the data store of the first data center, a current processing status of each of the incident messages based on indications received from the QAPI. In some implementations, the first worker sub-system and the second worker sub-system retrieve a current processing status of each of the first incident message and the incident messages of the first locked group (e.g., as described with respect to FIG. 5). The retrieving of the status is performed prior to the first worker sub-system retrieving the first incident message from the message stream data structure and prior to the second worker sub-system retrieving the incident messages of the first locked group from the group stream data structure.

In some implementations, the first worker sub-system processes the first incident message, and the second worker sub-system processes the incident messages of the first locked group. The processing can include one or more operations that are performed to resolve the incident messages or prepare them to be resolved, e.g., by an operator. The processing can include, for example, retrieving, via an inquiry from the QAPI, additional information regarding respective incidents associated with the first incident message and/or the first locked group. The processing can include assigning the first incident message and/or the first locked group to an operator and creating and transmitting an indication regarding the assignment to the operator. The processing can include determining that the first incident message and/or the first locked group requires resolution by an outside vendor operator and transmitting the first incident message and/or the first locked group to the outside vendor operator.

In some implementations, the first worker sub-system is configured to process incident messages of the unordered type only and the second worker sub-system is configured to process incident messages of the ordered type only. In such implementation, the first worker sub-system only processes unordered messages and the second worker sub-system only processes ordered messages.

In some implementations, the second worker sub-system is configured to balance its processing bandwidth by determining, using the current processing status of the multiple locked groups, a number of multiple locked groups it has the capacity to process. The second worker sub-system can be configured to retrieve, concurrently with retrieving the incident messages of a first locked group, additional one or more locked groups of the multiple locked groups based on the determination. Retrieval of such additional locked groups can ensure maximum processing and resource usage of the second worker subsystem.

In some implementations, the QAPI further receives an additional incident message. The additional incident message can include a particular incident identifier associated with a particular incident. The additional incident message can be of the ordered type. The QAPI can determine, using the particular incident identifier, whether the group stream data structure includes other incident messages comprising the particular incident identifier (e.g., as described with respect to FIG. 4). Responsive to a determination that a particular locked group at the group stream data structure comprises other incident messages comprising the particular incident identifier, the QAPI can add the additional incident message to the particular locked group.

In some implementations, the additional incident message is added to the group stream 304 in FIG. 3 before the group associated with the additional incident message is locked. For example, as described with respect to FIG. 5, the locking can be performed in response to the worker sub-system 310 and prior to the locking, the incident messages in the group stream 304 are not arranged in locked groups but rather in a stream of incident messages.

In some implementations, the QAPI receives the incident messages from a load balancer (e.g., the load balancer 204 in FIG. 2) in communication with the QAPI of the first data center and additional one or more QAPIs of additional one or more data centers. The load balancer can be configured to manage the processing bandwidths of the first data center and the additional one or more data centers.

### Computer System

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, video display device 718, an input/output device 720, a control device 722 (e.g., keyboard and pointing device), a drive unit 724 that includes a storage medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 700. In some implementation, the computer system 700 can be an embedded computer system, a system-on-chip (SOC), a single-board computer system (SBC) or a distributed system such as a mesh of computer systems or include one or more cloud components in one or more networks. Where appropriate, one or more computer systems 700 can perform operations in real-time, near real-time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable (storage) medium 726 can include any medium that is capable of storing, encoding, or carrying a set of instructions for execution by the computing system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### Remarks

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

I/We claim:

1. A computer-implemented method for managing incident processing queues in geographically distributed data centers, the method comprising:
receiving, by a queue application programming interface (QAPI) of a first data center, incident messages,
wherein the first data center is in communication with one or more additional data centers,
wherein each of the incident messages comprises an incident identifier associated with an incident;
wherein the incident messages include incident messages of an ordered type and unordered type,
wherein incident messages of the ordered type, associated with a particular incident, are required to be processed in a relative order they were received, and
wherein incident messages of the unordered type are not required to be processed in an order; and
(i) transmitting, by the QAPI of the first data center, the incident messages to a message stream data structure of a data store of the first data center and retrieving, by a first worker sub-system from the message stream data structure, a first incident message of a first subset of the incident messages of the unordered type for processing; and
in parallel with (i):
(ii) transmitting, by the QAPI of the first data center, the incident messages to a group stream data structure of the data store of the first data center;
arranging, by the group stream data structure, the incident messages into multiple locked groups; and
retrieving, by a second worker sub-system from the group stream data structure, incident messages of a first locked group of the multiple locked groups of the ordered type for processing,
wherein a least one of the first worker sub-system and the second worker subsystem is associated with the one or more additional data centers different from the first data center.

2. The computer-implemented method of claim 1,
wherein the first data center is separate from the one or more additional data centers and is located a distance away from the one or more additional data centers.

3. The computer-implemented method of claim 1, further comprising:
storing, by a state data structure of the data store of the first data center, a current processing status of each of the incident messages based on indications received from the QAPI.

4. The computer-implemented method of claim 1, further comprising:
prior to retrieving, by the first worker sub-system from the message stream data structure, the first incident message and retrieving, by the second worker subsystem from the group stream data structure, the incident messages of the first locked group,
retrieving a current processing status of each of the first incident message and the incident messages of the first locked group.

5. The computer-implemented method of claim 1,
wherein the first worker sub-system is configured to process incident messages of the unordered type only, and
wherein the second worker sub-system is configured to process incident messages of the ordered type only.

6. The computer-implemented method of claim 1,
wherein the first incident message and the incident messages of the first locked group are associated with a common software incident and comprise a common incident identifier.

7. The computer-implemented method of claim 1,
wherein the incident messages of the first locked group are associated with particular software incidents and are configured to be processed in an order they were received by the QAPI.

8. The computer-implemented method of claim 1,
wherein the second worker sub-system is configured to balance its processing bandwidth by determining, using a current processing status of the multiple locked groups, a number of multiple locked groups of the multiple locked groups it has capacity to process, and
wherein the second worker sub-system is configured to retrieve, concurrently with retrieving the incident messages of the first locked group, additional locked groups of the multiple locked groups based on the determination.

9. The computer-implemented method of claim 1, further comprising:
receiving, by the QAPI, an additional incident message, the additional incident message including a particular incident identifier associated with a particular incident, the additional incident message being of the ordered type;
determining, using the particular incident identifier, whether the group stream data structure comprises other incident messages comprising the particular incident identifier; and
responsive to a determination that a particular locked group at the group stream data structure comprises other incident messages comprising the particular incident identifier, adding the additional incident message to the particular locked group.

10. The computer-implemented method of claim 1,
wherein the QAPI receives the incident messages from a load balancer in communication with the QAPI of the first data center and additional one or more QAPIs of additional one or more data centers, and
wherein the load balancer is configured to manage processing bandwidths of the first data center and the additional one or more data centers.

11. The computer-implemented method of claim 1, further comprising:
processing, by the first worker sub-system, the first incident message; and
processing, by the second worker sub-system, the incident messages of the first locked group.

12. The computer-implemented method of claim 1,
wherein processing by the first worker sub-system and/or the second worker subsystem comprises retrieving, via an inquiry from the QAPI, additional information regarding respective incidents associated with the first incident message and/or the first locked group.

13. The computer-implemented method of claim 1,
wherein processing by the first worker sub-system and/or the second worker subsystem comprises:
assigning the first incident message and/or the first locked group to an operator; and
creating and transmitting an indication regarding the assignment to the operator.

14. The computer-implemented method of claim 1,
wherein processing by the first worker sub-system and/or the second worker subsystem comprises:
determining that the first incident message and/or the first locked group requires resolution by an outside vendor operator; and
transmitting the first incident message and/or the first locked group to the outside vendor operator.

15. A system for managing incident processing queues, the system comprising:
at least one hardware processor; and
at least one non-transitory memory storing instructions, which, when executed by the at least one hardware processor, cause the system to:
receive, by a queue application programming interface (QAPI) of a data center, incident messages,
wherein each of the incident messages comprises an incident identifier associated with an incident;
wherein the incident messages include incident messages of an ordered type and unordered type,
wherein incident messages of the ordered type, associated with a particular incident, are required to be processed in a relative order they were received, and
wherein incident messages of the unordered type are not required to be processed in an order; and
(i) transmit, by the QAPI, the incident messages to a message stream data structure of a data store of the data center, and retrieve, by a first worker sub-system from the message stream data structure, a first incident message of a first subset of the incident messages of the unordered type for processing; and
in parallel with (i):
(ii) transmit, by the QAPI, the incident messages to a group stream data structure of the data store of the data center;
arrange, by the group stream data structure, the incident messages into multiple locked groups; and
retrieve, by a second worker sub-system from the group stream data structure, incident messages of a first locked group of the multiple locked groups of the ordered type for processing.

16. The system of claim 15, further comprising:
storing, by a state data structure of the data store of the first data center, a current processing status of each of the incident messages based on indications received from the QAPI.

17. The system of claim 15, further comprising:
prior to retrieving, by a first worker sub-system from the message stream data structure, the first incident message of the first subset of the incident messages and retrieving, by a second worker sub-system from the group stream data structure, the incident messages of the first locked group of the multiple locked groups,
retrieving a current processing status of each of the first incident message and the incident messages of the first locked group.

18. A non-transitory, computer-readable storage medium comprising instructions recorded thereon, wherein the instructions, when executed by at least one data processor of a system, cause the system to:
receive, by a queue application programming interface (QAPI) of a data center, incident messages,
wherein each of the incident messages comprises an incident identifier associated with an incident;
wherein the incident messages include incident messages of an ordered type and unordered type,
wherein incident messages of the ordered type, associated with a particular incident, are required to be processed in a relative order they were received, and
wherein incident messages of the unordered type are not required to be processed in an order; and
(i) transmit, by the QAPI, the incident messages to a message stream data structure of a data store of the data center and retrieve, by a first worker sub-system from the message stream data structure, a first incident message of a first subset of the incident messages of the unordered type for processing; and
in parallel with (i):
(ii) transmit, by the QAPI, the incident messages to a group stream data structure of the data store of the data center;
arrange, by the group stream data structure, the incident messages into multiple locked groups; and
retrieve, by a second worker sub-system from the group stream data structure, incident messages of a first locked group of the multiple locked groups of the ordered type for processing.

19. The non-transitory, computer-readable storage medium of claim 18, further comprising:
storing, by a state data structure of the data store of the first data center, a current processing status of each of the incident messages based on indications received from the QAPI.

20. The non-transitory, computer-readable storage medium of claim 18, further comprising:
prior to retrieving, by a first worker sub-system from the message stream data structure, the first incident message of the first subset of the incident messages and retrieving, by a second worker sub-system from the group stream data structure, the incident messages of the first locked group of the multiple locked groups,
retrieving a current processing status of each of the first incident message and the incident messages of the first locked group.
